(19) United States
(12) Patent Application Publication
(10) Pub. No.: US 2026/0330593 A1
(43) Pub. Date: Oct. 22, 2026

(54) REMOTE COMMUNICATION SYSTEM AND REMOTE COMMUNICATION METHOD

(71) Applicant: Mitsubishi Electric Corporation, Tokyo (JP)

(72) Inventors: Masaki HARUNA, Tokyo (JP); Shigeaki TAGASHIRA, Osaka (JP); Masaki OGINO, Osaka (JP)

(73) Assignee: Mitsubishi Electric Corporation, Tokyo (JP)

(21) Appl. No.: 19/119,444

(22) PCT Filed: Oct. 28, 2022
(86) PCT No.: PCT/JP2022/040481

§ 371 Date: Apr. 9, 2025

(51) Int. Cl. G06T 3/4038; G06F 1/16

(52) U.S. Cl. CPC G06T 3/4038; G06F 1/1601; G06T 2200/32

(57) ABSTRACT

A remote communication system according to the present disclosure includes a terminal device including a display unit and a camera provided in the display unit, and operable by a second user who performs remote communication with a first user, an extended monitor including a display surface, the terminal device being disposed on the display surface side such that the display unit is placed on or over the display surface when viewed from the second user, and an image processing device that generates, using a captured image of the first user, a first image that is part of the image and is to be displayed on the terminal device, and a second image that is at least part of the image. The first image is a partial image to be displayed in an area corresponding to the display unit when the image is assumed to be displayed on the extended monitor.

### FIELD

The present disclosure relates to a remote communication system and a remote communication method.

### BACKGROUND

In recent years, remote communication that is communication between users located in different places has been used in various situations. In remote communication, for example, a first user who is a person on the other end of the communication is projected on a monitor, an image of a second user located in front of the monitor is captured from the monitor side, and the captured image is projected on a monitor in front of the second user. Remote communication uses captured images and thus is restricted in the positions of image-capturing devices, and has difficulty in aligning the lines of sight between users.

Patent Literature 1 discloses a technique in which a suction cup is attached to the back of an image-capturing device, and the image-capturing device is fixed to a display surface of a monitor using the suction cup in order to capture images of a user from a position close to the line of sight of a person on the other end in remote communication. This allows the image-capturing device to be fixed at a desired position on the display screen of the monitor so as to capture images from the position close to the line of sight of a person on the other end.

### CITATION LIST

### Patent Literature

Patent Literature 1: Japanese Patent Application Laid-open No. H07-154661

### SUMMARY OF INVENTION

### Problem to be Solved by the Invention

However, the technique described in Patent Literature 1 makes it impossible for the user to see a portion of an image where the image-capturing device is fixed. To make eye contact with a person on the other end of remote communication, the image-capturing device should be fixed to a portion corresponding to the position of the eyes in an image. In this case, an image portion of the eyes of the person on the other end of the remote communication is hidden behind the image-capturing device. This causes a problem in that the user cannot establish eye contact with the person on the other end.

The present disclosure has been made in view of the above. It is an object of the present disclosure to provide a remote communication system that allows a user to establish eye contact with a person on the other end of remote communication.

### Means to Solve the Problem

In order to solve the above-described problems and achieve the object, a remote communication system according to the present disclosure comprises: a terminal device including a display unit and a camera provided in the display unit, the terminal device being operable by a second user who performs remote communication with a first user; an extended monitor including a display surface, the terminal device being disposed on the display surface side such that the display unit is placed on or over the display surface when viewed from the second user. The remote communication system further comprises an image processing device to generate, using a captured image of the first user, a first image that is part of the image and is to be displayed on the terminal device, and a second image that is at least part of the image, wherein the first image is a partial image to be displayed in an area corresponding to the display unit when the image is assumed to be displayed on the extended monitor.

### Effects of the Invention

The remote communication system according to the present disclosure has an advantage of allowing a user to establish eye contact with a person on the other end of remote communication.

### BRIEF DESCRIPTION OF DRAWINGS

FIG. 1 is a diagram illustrating an exemplary configuration of a remote communication system according to a first embodiment.

FIG. 2 is a diagram illustrating an exemplary arrangement of a terminal device and an extended monitor in the first embodiment.

FIG. 3 is a diagram illustrating an exemplary arrangement of the terminal device and the extended monitor in the first embodiment.

FIG. 4 is a diagram illustrating an example of a first image and a second image in the first embodiment.

FIG. 5 is a diagram for explaining an effect of the first embodiment.

FIG. 6 is a flowchart illustrating an example of an image processing procedure of the first embodiment.

FIG. 7 is a diagram illustrating a first different exemplary configuration of the remote communication system of the first embodiment.

FIG. 8 is a diagram illustrating a second different exemplary configuration of the remote communication system of the first embodiment.

FIG. 9 is a diagram illustrating a third different exemplary configuration of the remote communication system of the first embodiment.

FIG. 10 is a diagram illustrating an exemplary configuration of a computer system that implements an image processing device in the first embodiment.

FIG. 11 is a diagram illustrating an exemplary configuration of a remote communication system according to a second embodiment.

FIG. 12 is a diagram illustrating an example of an image shift in the second embodiment.

FIG. 13 is a flowchart illustrating an example of an image processing procedure of the second embodiment.

FIG. 14 is a diagram illustrating an exemplary configuration of a remote communication system according to a third embodiment.

FIG. 15 is a flowchart illustrating an example of an image processing procedure of the third embodiment.

FIG. 16 is a diagram illustrating an exemplary configuration of a remote machine operation system according to a fourth embodiment.

FIG. 17 is a diagram illustrating how a terminal device and an extended monitor are used in the fourth embodiment.

FIG. 18 is a diagram illustrating how the terminal device and the extended monitor are used in the fourth embodiment.

### DESCRIPTION OF EMBODIMENTS

Hereinafter, a remote communication system and a remote communication method according to embodiments will be described in detail with reference to the drawings.

### First Embodiment

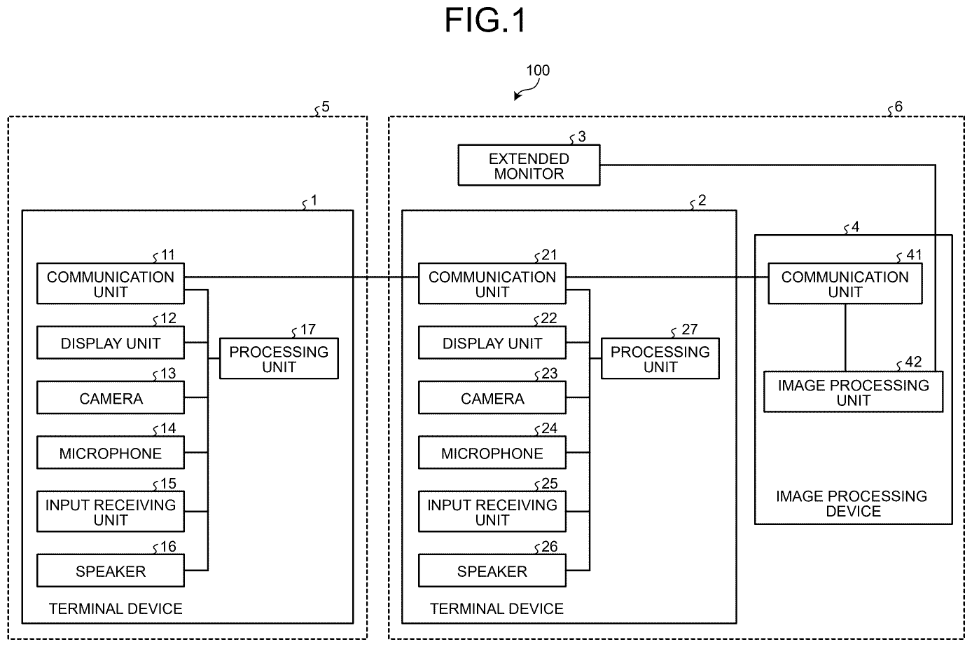

FIG. 1 is a diagram illustrating an exemplary configuration of a remote communication system according to a first embodiment. A remote communication system 100 of the present embodiment supports remote communication between a first user located at a first point 5 and a second user located at a second point 6 that is a place different from the first point 5. A terminal device 1 that is a first terminal device is provided at the first point 5. The terminal device 1 captures images of the first user and transmits the captured images to the second point 6.

The remote communication system 100 of the present embodiment includes a terminal device 2 that is a second terminal device, an extended monitor 3, and an image processing device 4. Although FIG. 1 illustrates an example in which the terminal device 2, the extended monitor 3, and the image processing device 4 are provided at the second point 6, it is only required that the terminal device 2 and the extended monitor 3 be provided at the second point 6, and the image processing device 4 may be provided at a place other than the second point 6. Note that the terminal device 1 may be included in the remote communication system 100.

The terminal device 1 is, for example, a smartphone, a tablet, a personal computer, or the like, but is not limited thereto. The terminal device 1 includes a communication unit 11, a display unit 12, a camera 13, a microphone 14, an input receiving unit 15, a speaker 16, and a processing unit 17.

The processing unit 17 performs various types of processing in the terminal device 1. For example, the processing unit 17 controls transmission and reception of images and sound for remote communication between the first user who is the user of the terminal device 1, and the second user who is the user of the terminal device 2. The communication unit 11 communicates with other devices. For example, under the control of the processing unit 17, the communication unit 11 transmits images captured by the camera 13 and sound collected by the microphone 14 to the terminal device 2. Furthermore, for example, under the control of the processing unit 17, the communication unit 11 receives images (images showing the second user to be described below) and sound (an electrical signal of sound including the second user's voice) from the terminal device 2. The images received by the communication unit 11 are displayed by the display unit 12, and the sound received by the communication unit 11 is output by the speaker 16. Here, an example in which sound is transmitted and received together with images between the terminal device 1 and the terminal device 2 will be described, but it is only necessary that images be transmitted and received, and transmission and reception of sound is not essential. Instead of sound, text data or the like may be transmitted and received between the terminal device 1 and the terminal device 2.

The display unit 12 displays various types of information. For example, the display unit 12 displays images received by the communication unit 11. When the communication unit 11 receives data such as text for remote communication from the terminal device 2, the display unit 12 may display the data. The camera 13 captures images.

For example, the camera 13 captures images of the first user and outputs the captured images to the communication unit 11. The microphone 14 converts sound into an electrical signal. For example, the microphone 14 converts sound including the first user's voice into an electrical signal, and outputs the sound converted into the electrical signal to the communication unit 11.

The input receiving unit 15 receives input from the first user and outputs input information indicating the content of the received input to the processing unit 17. For example, the input receiving unit 15 receives input of an instruction to start remote communication with the second user, and outputs input information indicating the content of the input to the processing unit 17. Consequently, the processing unit 17 starts control of operation in the terminal device 1 for performing remote communication. In the case where input information such as text is transmitted from the terminal device 1 to the terminal device 2 in remote communication, input information received by the input receiving unit 15 is transmitted to the terminal device 2 via the communication unit 11. The speaker 16 outputs voice input as an electrical signal as sound. For example, the speaker 16 outputs, as sound, an electrical signal of sound received by the communication unit 11 from the terminal device 2.

The terminal device 2 at the second point 6 is a terminal device operable by the second user who performs remote communication with the first user. Similarly to the terminal device 1, the terminal device 2 is, for example, a smartphone, a tablet, a personal computer, or the like, but is not limited thereto. The terminal device 2 includes a communication unit 21, a display unit 22, a camera 23, a microphone 24, an input receiving unit 25, a speaker 26, and a processing unit 27. The basic functions of the communication unit 21, the display unit 22, the camera 23, the microphone 24, the input receiving unit 25, the speaker 26, and the processing unit 27 are the same as those of the communication unit 11, the display unit 12, the camera 13, the microphone 14, the input receiving unit 15, the speaker 16, and the processing unit 17 of the terminal device 1, respectively. However, the user at the terminal device 2 is changed from the first user to the second user, and a communications partner of the terminal device 2 is the terminal device 1. That is, for example, the camera 23 captures images of the second user, and the microphone 24 converts sound including the second user's voice into an electrical signal. The communication unit 21 receives images (images showing the first user) and sound (sound including the first user's voice) from the terminal device 1. The speaker 26 outputs, as sound, an electrical signal of sound received by the communication unit 21 from the terminal device 1. The communication unit 21 transmits an image received from the terminal device 1 to the image processing device 4, and receives an image for the terminal device 2 to be described below from the image processing device 4. The image for the terminal device 2 is part of the image transmitted from the terminal device 1. The image for the terminal device 2 received by the communication unit 21 is displayed by the display unit 22.

A communication line between the terminal device 1 and the terminal device 2 may be a wireless communication line or a wired communication line. A communication line between the terminal device 2 and the image processing device 4 may also be a wireless communication line or a wired communication line.

As described above, using the terminal device 1 and the terminal device 2 enables remote communication between the first user and the second user. For detailed processing for enabling remote communication between the first user and the second user other than image processing to be described below, any processing may be used. For example, typical processing for remote communication can be used, and thus detailed description thereof will be omitted. There is no particular limitation on the purpose of remote communication, which may be communication related to a conference, education, leisure, or remote operation, or the like, or may be other than these.

Here, an example in which an image of the first user is captured by the terminal device 1 will be described, but the present invention is not limited thereto. An image showing the first user may be captured by an external camera separate from the terminal device 1, or may be an image captured by a camera module virtually disposed in a virtual reality (VR) space. For example, in the case where the first user is present in a VR space as an avatar or the like, an image of the first user may be an image captured by a camera module virtually disposed in the VR space.

When an image captured by the camera 13 of the terminal device 1 is displayed on the display unit 22 of the terminal device 2, the second user can see the first user in the image. On the other hand, remote communication is performed through images, and thus it is difficult to make eye contact with the person on the other end. To make eye contact, the camera 23 should be disposed at a position corresponding to the line of sight. If the camera 23 is disposed in front of the display unit 22, a portion of the image behind the camera 23 is hidden. A method of using a half mirror is conceivable, which, however, increase the size of the device. In order to solve these problems, a camera disposed under a display such as a liquid crystal panel, called a so-called in-camera, front camera, or the like (referred to as an embedded camera) can be used. That is, the camera 23 is provided in the display unit 22, and is, for example, a camera capable of capturing the display unit 22 side from the inside of the display unit 22. In the present embodiment, a camera disposed under a display is used as the camera 23. That is, in the present embodiment, the camera 23 embedded under the display unit 22 is used as the camera 23. This solves the above problems.

For example, many smartphones, tablets, and the like are equipped with an embedded camera, and it is possible to use this camera. However, the embedded camera thereof is generally provided in an end portion of the display unit 22. In general, remote communication is often performed with the face of a person on the other end displayed in and near the center of the display unit 22. Therefore, when the camera 23 is provided in the end portion of the display unit 22, it is impossible to make eye contact.

In the present embodiment, the extended monitor 3 is provided to allow the second user to make eye contact with the first user even when the camera 23 is provided in the end portion of the display unit 22. The extended monitor 3 has a display surface. The terminal device 2 is disposed on the display surface side of the extended monitor 3 such that the display unit 22 is placed on or over the display surface when viewed from the second user. The image processing device 4 generates an image for the terminal device 2 and an image for the extended monitor 3 such that a seamless image is projected on the display unit 22 of the terminal device 2 and the extended monitor 3. Specifically, the image processing device 4 generates an image for the terminal device 2 (first image) and an image for the extended monitor 3 (second image) from an image received from the terminal device 1. The display unit 22 displays the first image, and the extended monitor 3 displays the second image. The first image is a partial image to be displayed in an area corresponding to the display unit 22 if the image received from the terminal device 1 is assumed to be displayed on the extended monitor 3. The second image is at least part of the image received from the terminal device 1, and is seamlessly continuous with the first image. Consequently, the remote communication system 100 of the present embodiment allows natural eye contact to be established.

The image processing device 4 includes a communication unit 41 and an image processing unit 42. The communication unit 41 receives an image from the terminal device 2 and outputs the image to the image processing unit 42. The image processing unit 42 generates a first image that is an image for the terminal device 2 and a second image that is an image for the extended monitor 3 from the received image, outputs the first image to the communication unit 41, and outputs the second image to the extended monitor 3. The communication unit 41 transmits the first image to the terminal device 2. FIG. 1 illustrates an example in which the image processing device 4 is connected to the extended monitor 3 by an image transmission cable or the like, and the second image is transmitted (output) from the image processing unit 42 to the extended monitor 3 through the cable or the like. However, the present invention is not limited thereto. The extended monitor 3 may have a communication function, and the second image may also be transmitted to the extended monitor 3 via the communication unit 41.

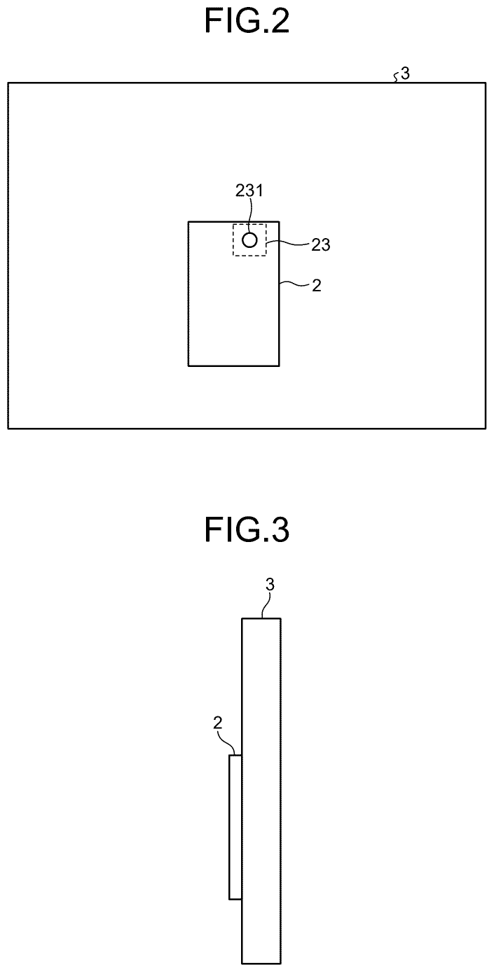

FIGS. 2 and 3 are diagrams illustrating an exemplary arrangement of the terminal device 2 and the extended monitor 3 in the present embodiment. FIG. 2 schematically illustrates the terminal device 2 and the extended monitor 3 when viewed from the display surface side of the extended monitor 3. FIG. 3 schematically illustrates the terminal device 2 and the extended monitor 3 when viewed from the side surface side of the extended monitor 3. In FIG. 3, the left side is the display surfaces of the extended monitor 3 and the display unit 22 of the terminal device 2. As illustrated in FIGS. 2 and 3, the terminal device 2 is disposed on the display surface of the extended monitor 3. A lens 231 in FIG. 2 is a lens in the camera 23 of the terminal device 2.

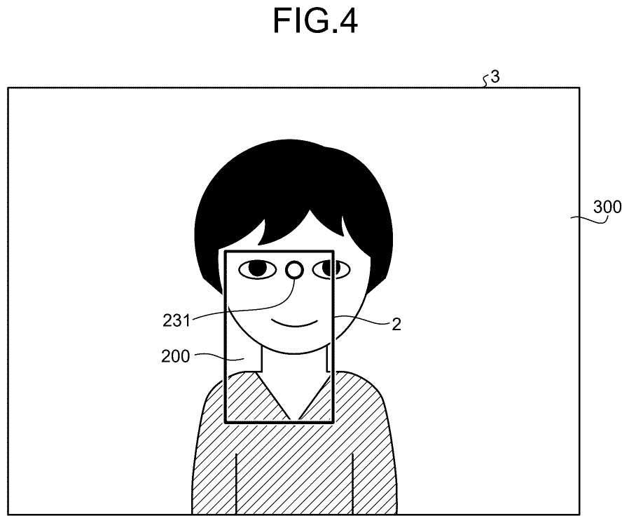

FIG. 4 is a diagram illustrating an example of the first image and the second image in the present embodiment. In the example illustrated in FIG. 4, as illustrated in FIGS. 2 and 3, the terminal device 2 is disposed on the display surface of the extended monitor 3. A partial image 200 that is an example of the first image is displayed on the terminal device 2. A partial image 300 that is an example of the second image is displayed on the extended monitor 3. The partial image 200 is seamlessly continuous with the partial image 300. In FIG. 3, the back of the terminal device 2 is in contact with the display surface of the extended monitor 3, but the back of the terminal device 2 may be away from the display surface of the extended monitor 3. However, if the back of the terminal device 2 is too far from the display surface of the extended monitor 3, there is a possibility that the images cannot be continuous. Therefore, the distance between the back of the terminal device 2 and the display surface of the extended monitor 3 is preferably less than or equal to a certain value. FIG. 4 illustrates an example in which the terminal device 2 is a bezel-less terminal device called a so-called bezel-less smartphone, bezel-less tablet, or the like, the display unit 22 of the terminal device 2 spreads over the entire surface of the terminal device 2, and the display unit 22 has no bezel or a very thin bezel. The bezel-less terminal device 2 has a smaller portion where an image is hidden, but the present invention is not limited to bezel-less terminal devices. A terminal device having the display unit 22 with a bezel may be used.

The partial image 200 is a divided portion of the image received by the terminal device 2 from the terminal device 1, that is, part of the image received by the terminal device 2 from the terminal device 1. The partial image 300 is the image received by the terminal device 2 from the terminal device 1 from which the partial image 200 portion is removed. The second image, which is the image for the extended monitor 3, may be the entire image received by the terminal device 2 from the terminal device 1. When the image received by the terminal device 2 from the terminal device 1 is displayed on the display unit 22, the image may be enlarged by the operation of the second user. In this case, the first image is part of the enlarged image, and the second image may be the enlarged image from which the first image portion is removed, or may be the entire enlarged image.

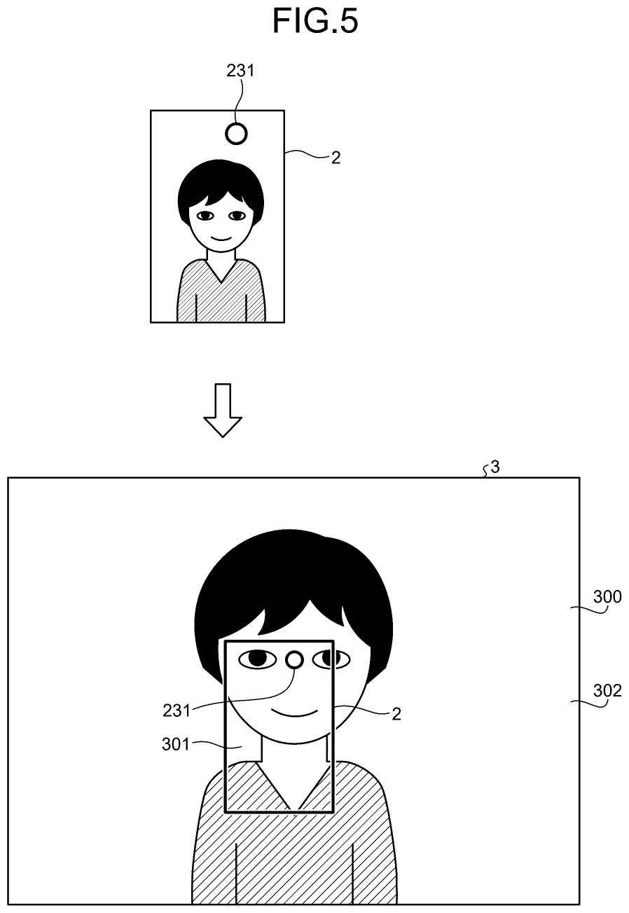

FIG. 5 is a diagram for explaining an effect of the present embodiment. An upper part of FIG. 5 illustrates an example in which the terminal device 2 displays an image received from the terminal device 1 as it is. A lower part of FIG. 5 illustrates an example in which the image received from the terminal device 1 is divided into a partial image 301 for the terminal device 2 and a partial image 300 for the extended monitor 3 and displayed as in FIG. 4. As illustrated in the upper part of FIG. 5, the lens 231 of the camera 23 in the terminal device 2 is disposed near the upper end of the terminal device 2. In this case, to remotely communicate with the first user, the second user turns the eyes to and near the eyes of the first user displayed as the image on the terminal device 2, to make eye contact with the first user. However, since the position of the lens 231 in the terminal device 2 is near the upper end of the terminal device 2, the second user is captured from a position above a position corresponding to the second user's line of sight, and the lines of sight of the first user and the second user cannot be aligned. If the image is displayed such that the eyes of the first user are located at the position of the lens 231, the face of the first user is placed in an upper end portion, and the entire face is not displayed.

In contrast, in the lower diagram of FIG. 5, the face of the first user is displayed in and near the center of an entire image 302 into which the partial image 301 displayed on the terminal device 2 and the partial image 300 displayed on the extended monitor 3 are combined, and the lens 231 is disposed at a position corresponding to the position of the eyes of the first user. Therefore, by disposing the terminal device 2 on the extended monitor 3 such that, for example, the position of the camera 23 in the terminal device 2, that is, the position of the lens 231 is near the center of the extended monitor 3, the second user can establish eye contact with the first user. In the present embodiment, it is assumed that the position of the terminal device 2 on the extended monitor 3 is determined in advance. For example, a frame for disposing the terminal device 2 on the extended monitor 3 may be displayed on an adjustment screen, or a mark indicating the disposition position of the terminal device 2 may be provided on the extended monitor 3.

In the present embodiment, capturing an image of the second user from the position of the eyes of the person on the other end (for example, the center of both eyes of the person on the other end) projected as an image is referred to as line-of-sight alignment. For two-way line-of-sight alignment, it is desirable that an image of the first user be similarly captured from the position of the eyes of the person on the other end (for example, the center of both eyes of the person on the other end) projected as an image on the first user side. However, in the present embodiment, image capturing on the first user side may be free of this constraint.

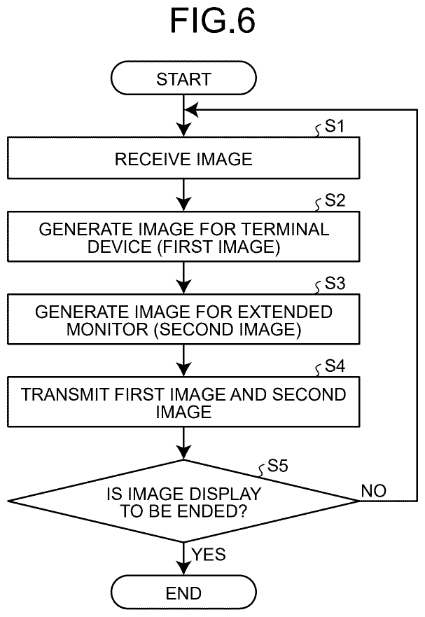

Next, the operation of the image processing device 4 in the present embodiment will be described. FIG. 6 is a flowchart illustrating an example of an image processing procedure of the present embodiment. As illustrated in FIG. 6, the image processing device 4 receives an image (step S1). Specifically, the communication unit 41 receives an image showing the first user from the terminal device 2, and outputs the received image to the image processing unit 42. The image received by the communication unit 41 may be the image itself received by the terminal device 2 from the terminal device 1, or may be the image enlarged on the basis of input of an instruction to enlarge the image received by the terminal device 2 from the second user.

Next, the image processing device 4 generates an image for the terminal device 2 (first image) (step S2). Specifically, the image processing unit 42 generates the first image by dividing the image received from the communication unit 41 into the first image that is an image of a portion corresponding to the position of the terminal device 2 on the extended monitor 3, and an image of the other portion. Assume that the position of the terminal device 2 on the extended monitor 3 is determined in advance, for example, and the image processing unit 42 holds position information indicating the position of the terminal device 2 on the extended monitor 3. The position of the terminal device 2 on the extended monitor 3 is determined such that the lens 231 in the terminal device 2 is disposed at the eye position when the first user is displayed as an image. The eye position is, for example, the center of both eyes, but is not limited thereto. The eye position is determined in advance on the assumption that the first user is displayed substantially in the center of the extended monitor 3, but the present invention is not limited thereto. The position information may be represented, for example, by coordinate values in an image to be displayed on the extended monitor 3 in units of pixels of the image. Alternatively, the position information may be information indicating the physical size of the display surface of the extended monitor 3, and coordinates representing the physical position of the terminal device 2 on the display surface of the extended monitor 3. Furthermore, the position information may be information indicating the positions of the four corners of the terminal device 2, or may be information indicating the position where the terminal device 2 is located in units of pixels.

Next, the image processing device 4 generates an image for the extended monitor 3 (second image) (step S3). Specifically, the image processing unit 42 uses, as the second image, the image other than that of the portion corresponding to the position of the terminal device 2 on the extended monitor 3, divided in step S2. Alternatively, the image itself received by the communication unit 41 may be used as the second image.

Next, the image processing device 4 transmits the first image and the second image (step S4). Specifically, the image processing unit 42 transmits the first image to the terminal device 2 via the communication unit 41, and transmits the second image to the extended monitor 3.

Next, the image processing device 4 determines whether or not to end the display of the image (step S5). When the display of the image is to be ended (step S5 Yes), the image processing device 4 ends the processing. When the display of the image is not to be ended (No in step S5), the image processing device 4 repeats the processing from step S1. In step S5, for example, the image processing unit 42 may determine that the display of the image is to be ended when receiving an instruction to end the display of the image from the terminal device 2 via the communication unit 41, or may determine that the display of the image is to be ended when not receiving an image from the communication unit 41 for a certain period of time or more.

Through the above processing, the terminal device 2 receives the first image from the image processing device 4 and displays the received first image. The extended monitor 3 receives the second image from the image processing device 4 and displays the received second image. Consequently, as illustrated in FIG. 4, the second user can see the first image and the second image that are seamlessly continuous as one image. As described with reference to FIGS. 4 and 5, even in the case where the lens 231 in the terminal device 2 is provided in the end portion of the terminal device 2, the second user can see the entire face of the first user while establishing eye contact with the first user.

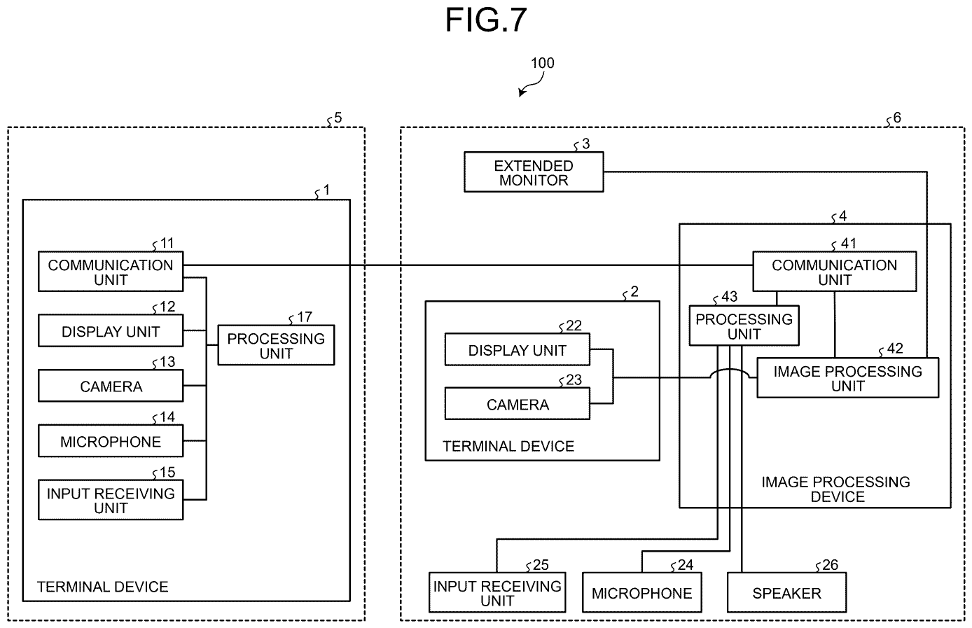

Although FIG. 1 illustrates an example in which the terminal device 2 is a smartphone, a tablet, or the like, the terminal device 2 only needs to include the display unit 22 and the camera 23, and the other components may be provided outside the terminal device 2. FIG. 7 is a diagram illustrating a first different exemplary configuration of the remote communication system 100 of the present embodiment. Components having the same functions as those in FIG. 1 are denoted by the same reference numerals as those in FIG. 1 to omit redundant descriptions. In the example illustrated in FIG. 7, the terminal device 2 includes the display unit 22 and the camera 23, and the function of the communication unit 21 is included in the communication unit 41 of the image processing device 4. That is, the image processing device 4 receives an image transmitted from the terminal device 1 and outputs the received image to the image processing unit 42.

In the example illustrated in FIG. 7, the input receiving unit 25, the microphone 24, and the speaker 26 are provided separately from the terminal device 2 and the image processing device 4. The image processing device 4 includes a processing unit 43. The processing unit 43 controls the terminal device 2, the input receiving unit 25, the microphone 24, and the speaker 26. For example, the processing unit 43 transmits input information indicating the content of input received by the input receiving unit 25 and sound collected by the microphone 24 to the terminal device 1 via the communication unit 41, and outputs sound received by the communication unit 41 to the speaker 26. As in the exemplary configuration illustrated in FIG. 1, the image processing device 4 generates a first image that is an image for the terminal device 2 and a second image that is an image for the extended monitor 3 from an image transmitted from the terminal device 1, and outputs the second image to the extended monitor 3 and outputs the first image to the communication unit 41.

Although all of the input receiving unit 25, the microphone 24, and the speaker 26 are provided outside in FIG. 7, the present invention is not limited thereto. At least one of the input receiving unit 25, the microphone 24, and the speaker 26 may be provided in the image processing device 4 or may be provided in the terminal device 2. A communication terminal including the communication unit 41 may be provided separately from the terminal device 2 and the image processing device 4, and the communication terminal may receive an image from the terminal device 1 and output the received image to the image processing device 4. Although FIG. 7 illustrates an example in which the terminal device 2 is connected to the image processing device 4 by a cable or the like, the terminal device 2 may include the communication unit 21, and interaction between the image processing device 4 and the terminal device 2 may be performed via the communication unit 41 and the communication unit 21.

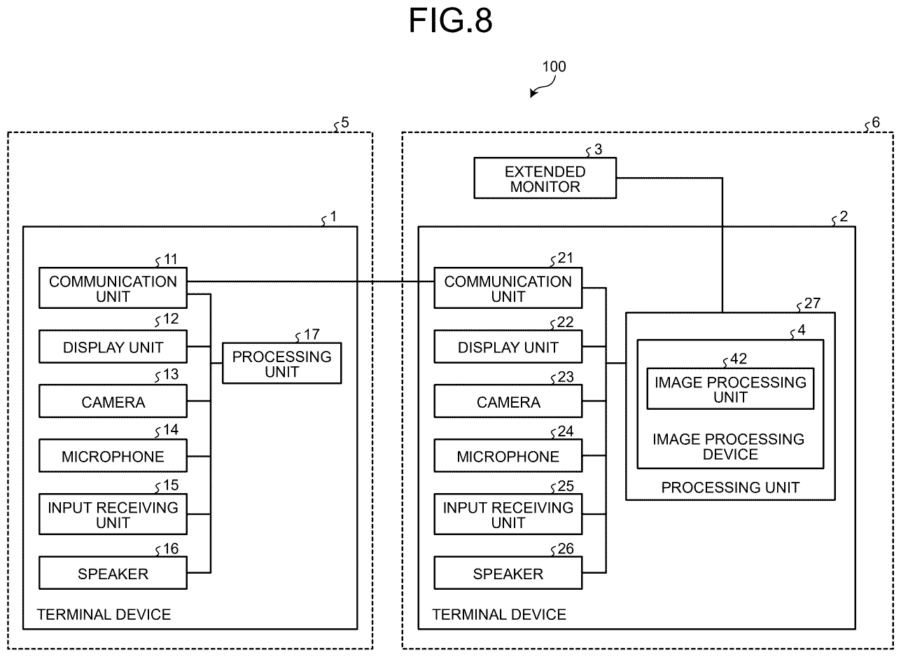

Although FIG. 1 illustrates an example in which the terminal device 2 and the image processing device 4 are separately provided, the image processing device 4 and the terminal device 2 may be integrated. FIG. 8 is a diagram illustrating a second different exemplary configuration of the remote communication system 100 of the present embodiment. In the example illustrated in FIG. 8, the image processing device 4 is provided in the processing unit 27 of the terminal device 2. Components having the same functions as those in FIG. 1 are denoted by the same reference numerals as those in FIG. 1 to omit redundant descriptions. In the example illustrated in FIG. 8, an example in which the image processing device 4 is provided in the processing unit 27 is illustrated, but the image processing device 4 may be provided in the terminal device 2 separately from the processing unit 27. In the example illustrated in FIG. 8, the second image generated by the image processing device 4 may also be transmitted to the extended monitor 3 via the communication unit 21.

Although FIG. 8 illustrates an example in which the image processing device 4 and the terminal device 2 are integrated, the extended monitor 3 and the image processing device 4 may be integrated. For example, the image processing device 4 may be connected to and integrated with the extended monitor 3 illustrated in FIG. 1, or the extended monitor 3 may be an information processing device with a monitor, such as a tablet or a personal computer, and the information processing device may have a function as the image processing device 4.

In the present embodiment, by using an in-camera or a front camera of a smartphone, a tablet, or the like, a simple device configuration enables line-of-sight alignment at the second point 6. It is preferable that a measure to allow line-of-sight alignment be also taken at the first point 5. This measure may be a method using the extended monitor 3 as at the second point 6, or may be another method. There is no particular constraint on a device configuration for allowing line-of-sight alignment at the first point 5. At the first point 5, as at the second point 6, a terminal device such as a smartphone, an extended monitor, and an image processing device may be provided, and the image processing device may similarly generate a first image for the terminal device and a second image for the extended monitor. In this case, the image processing device 4 that processes images to be displayed at the second point 6 and the image processing device that processes images to be displayed at the first point 5 may be the same. At the first point 5, by using a device configuration similar to that at the second point 6, a simple device configuration enables line-of-sight alignment.

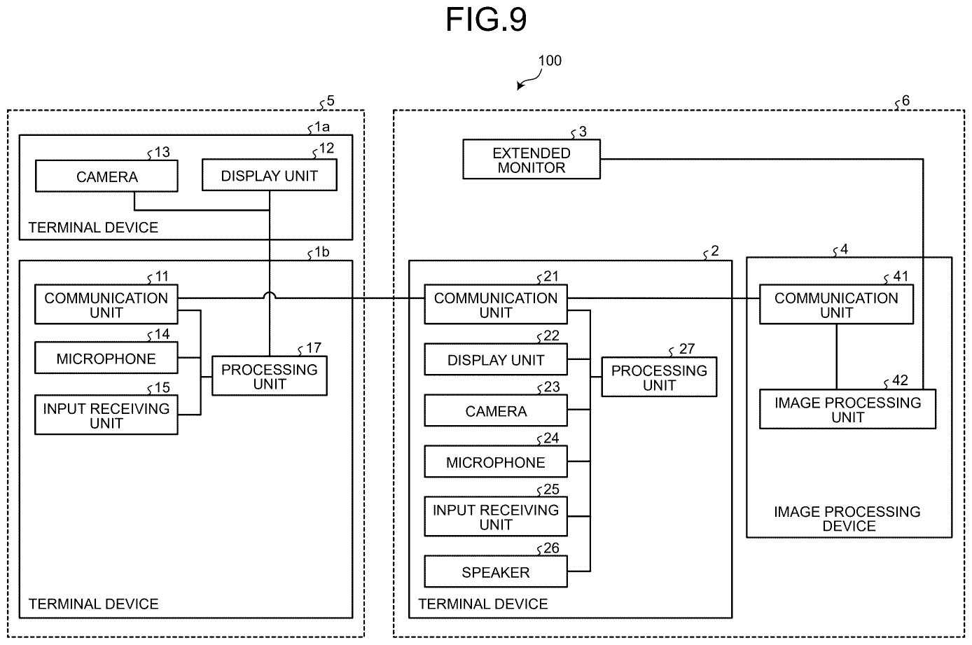

Although FIG. 1 illustrates an example in which the terminal device 1 that is an information processing device with a monitor, such as a smartphone, is provided at the first point 5, a plurality of devices may be provided separately at the first point 5. FIG. 9 is a diagram illustrating a third different exemplary configuration of the remote communication system 100 of the present embodiment. Components having the same functions as those in FIG. 1 are denoted by the same reference numerals as those in FIG. 1 to omit redundant descriptions. For example, as illustrated in FIG. 9, the terminal device 1 illustrated in FIG. 1 may be divided into a terminal device la that is a camera-equipped monitor and a terminal device 1b. The terminal device 1a includes the display unit 12 and the camera 13. The camera 13 is installed, for example, at a predetermined place where an image of the eyes of the second user is to be displayed on the display unit 12. For example, a hole may be provided in the surface of the display unit 12 at the predetermined place, and the camera 13 may be provided in the back of the hole. Although FIG. 9 illustrates an example in which the camera 13 is embedded in the terminal device 1a, a monitor that is the display unit 12 and the camera 13 may be separately provided. For example, the camera 13 may be disposed such that the lines of sight of the first user and the second user can be aligned, using a half mirror.

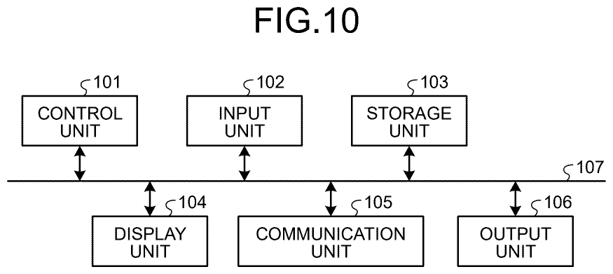

Next, a hardware configuration of each device of the present embodiment will be described. For the image processing device 4 of the present embodiment illustrated in FIG. 1, when a program that is a computer program describing the processing in the image processing device 4 is executed on a computer system, the computer system functions as the image processing device 4. FIG. 10 is a diagram illustrating an exemplary configuration of a computer system that implements the image processing device 4 in the present embodiment. As illustrated in FIG. 10, the computer system includes a control unit 101, an input unit 102, a storage unit 103, a display unit 104, a communication unit 105, and an output unit 106, which are connected via a system bus 107. The control unit 101 and the storage unit 103 constitute processing circuitry.

In FIG. 10, the control unit 101 is, for example, a processor such as a central processing unit (CPU), and executes a program describing the processing in the image processing device 4 of the present embodiment. Note that part of the control unit 101 may be implemented by dedicated hardware such as a graphics processing unit (GPU) or a field-programmable gate array (FPGA). The input unit 102 may be an input means such as buttons, a keyboard, a mouse, a joystick, a touch pad, and/or a game controller, or may be an input means that detects a gesture of a user on the basis of images showing the user or the movement of muscles of an operator, to receive input. The storage unit 103 includes various types of memory such as random-access memory (RAM) and read-only memory (ROM) and a storage device such as a hard disk, and stores the program to be executed by the control unit 101, necessary data obtained during the processing, etc. The storage unit 103 is also used as a temporary storage area for the program. As described above, the display unit 104 is, for example, a display or the like. The display unit 104 may be integrated with the input unit 102 to be implemented by a touch panel or the like. The communication unit 105 is a receiver and a transmitter that perform communication processing. The output unit 106 is a speaker or the like. Note that FIG. 10 is an example, and the configuration of the computer system is not limited to the example of FIG. 10. For example, in the present embodiment, the computer system that implements the image processing device 4 may not include the display unit 104 and the output unit 106.

Here, an example of operation of the computer system before the program of the present embodiment becomes executable will be described. In the computer system having the above-described configuration, the computer program is installed in the storage unit 103, for example, from a compact disc (CD)-ROM or a digital versatile disc (DVD)-ROM set in a CD-ROM drive or a DVD-ROM drive (not illustrated). At the time of execution of the program, the program read from the storage unit 103 is stored in the main storage area of the storage unit 103. In this state, the control unit 101 performs the processing as the image processing device 4 of the present embodiment, according to the program stored in the storage unit 103.

In the above description, the program describing the processing in the image processing device 4 is provided using the CD-ROM or DVD-ROM as a recording medium, which is not limiting. For example, the program provided through a transmission medium such as the Internet may be used, depending on the configuration of the computer system, the capacity of the program provided, etc.

The image processing unit 42 illustrated in FIG. 1 is implemented by the computer program stored in the storage unit 103 illustrated in FIG. 10 being executed by the control unit 101 illustrated in FIG. 10. The storage unit 103 illustrated in FIG. 10 is also used to implement the image processing unit 42 illustrated in FIG. 1. The communication unit 41 illustrated in FIG. 1 is implemented by the communication unit 105 illustrated in FIG. 10.

Each of the terminal device 1 and the terminal device 2 illustrated in FIG. 1 is also implemented, for example, by a computer system having the configuration illustrated in FIG. 10. In the example illustrated in FIG. 7, the image processing device 4 is implemented, for example, by a computer system having the configuration illustrated in FIG. 10. In the example illustrated in FIG. 7, the terminal device 2 only needs to include the display unit 22 such as a monitor or a display, and the camera 23, and may not be a computer system. In the example illustrated in FIG. 8, the terminal device 2 is implemented, for example, by a computer system having the configuration illustrated in FIG. 10. In the example illustrated in FIG. 9, the terminal device 1b is implemented, for example, by a computer system having the configuration illustrated in FIG. 10. In the example illustrated in FIG. 9, the terminal device 1a only needs to include the display unit 22 such as a monitor or a display, and the camera 23, and may not be a computer system.

As described above, the remote communication system 100 of the present embodiment displays a first image that is part of an image of the first user on the terminal device 2, and displays a second image that is seamlessly continuous with the first image on the extended monitor 3 provided at the back of the terminal device 2. The camera 23 is embedded in the display unit 22 of the terminal device 2. The camera 23 is disposed at a place corresponding to the eye position of the first user. This allows the second user to establish eye contact with the first user who is the person on the other end of remote communication, using the terminal device 2 with the camera 23 embedded in the end portion.

### Second Embodiment

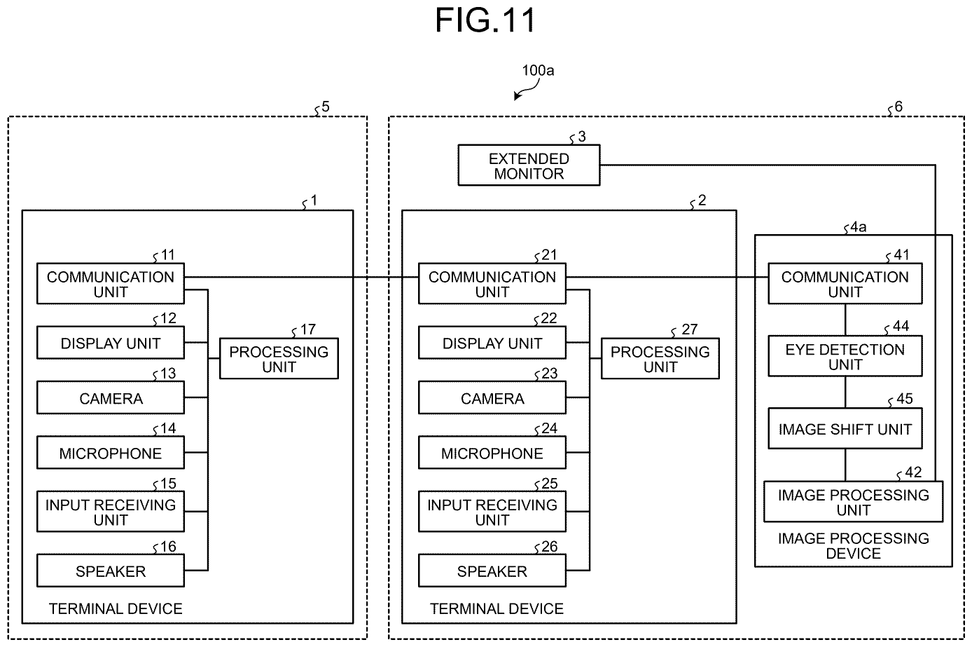

FIG. 11 is a diagram illustrating an exemplary configuration of a remote communication system according to a second embodiment. A remote communication system 100a of the present embodiment is the same as the remote communication system 100 of the first embodiment except that the remote communication system 100a includes an image processing device 4a instead of the image processing device 4. Components having the same functions as those in the first embodiment are denoted by the same reference numerals as those in the first embodiment to omit redundant descriptions. Hereinafter, differences from the first embodiment will be mainly described.

The image processing device 4a is the same as the image processing device 4 of the first embodiment except that the image processing device 4a includes an eye detection unit 44 and an image shift unit 45. The communication unit 41 outputs an image received from the terminal device 2 to the eye detection unit 44. The eye detection unit 44 detects the position of the eyes of the first user in the image received from the communication unit 41, and outputs the detection result to the image shift unit 45 together with the image. The position of the eyes is, for example, the center of both eyes, but is not limited thereto. The image shift unit 45 shifts the image received from the eye detection unit 44, using the detection result received from the eye detection unit 44, and outputs the shifted image to the image processing unit 42. Specifically, the image shift unit 45 shifts the image such that the position of the eyes detected by the eye detection unit 44 coincides with a position corresponding to the camera 23. The image processing unit 42 generates a first image and a second image as in the first embodiment, using the image that has been shifted by the image shift unit 45.

For example, a reference position for the eye position in an image is determined in advance, and the image shift unit 45 shifts the image by the difference between the reference position and the detection result.

For example, the image shift unit 45 shifts the image by X0-Xe and Y0-Ye where X0 and Y0 are the coordinates of the reference position, and Xe and Ye are the coordinates of the detection result. Processing in the image processing unit 42 is the same as that in the first embodiment, but the position of the terminal device 2 is determined such that the position of the lens 231 is the above-described reference position.

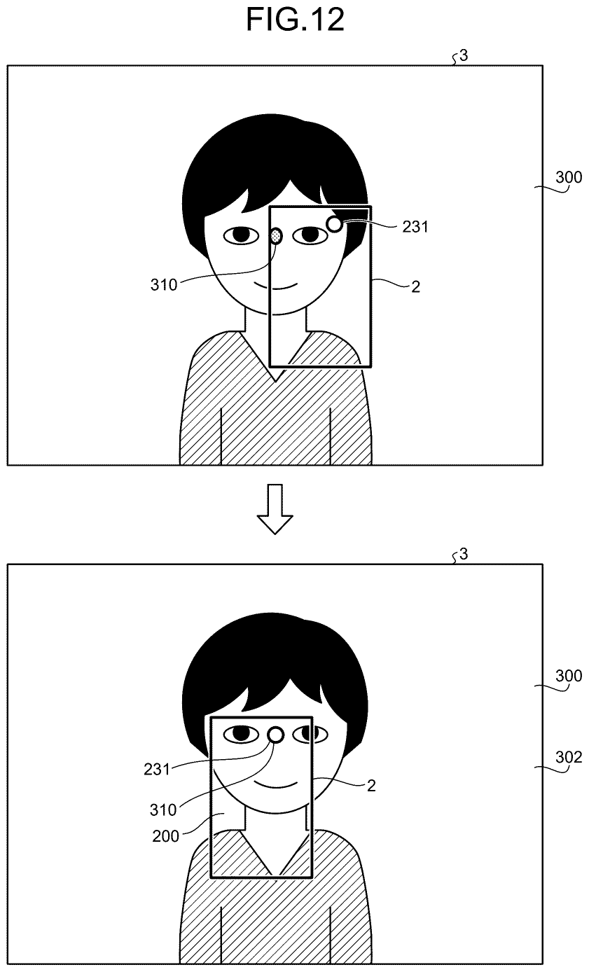

FIG. 12 is a diagram illustrating an example of an image shift in the present embodiment. An upper part of FIG. 12 illustrates a display example when an image shift is not performed. A lower part of FIG. 12 illustrates a display example when an image shift is performed. As illustrated in the upper part of FIG. 12, when an image shift is not performed, an eye position 310 is slightly off the position of the lens 231 in the terminal device 2, that is, the position of the camera 23 in the terminal device 2. In the present embodiment, the image is shifted as illustrated in the lower part of FIG. 12, using the result of detection of the eye position 310 in the image, so that the eye position 310 can be aligned with the position of the camera 23 in the terminal device 2.

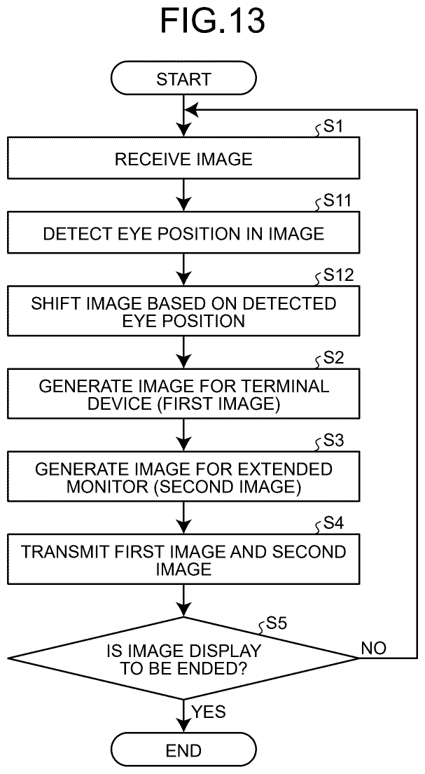

FIG. 13 is a flowchart illustrating an example of an image processing procedure of the present embodiment. Step S1 is similar to that in the first embodiment, but the communication unit 41 outputs a received image to the eye detection unit 44. Next, the eye detection unit 44 detects the position of eyes in the image (step S11). The eye detection unit 44 outputs the detection result to the image shift unit 45 together with the image. Next, the image shift unit 45 shifts the image (step S12). Specifically, the image shift unit 45 shifts the image received from the eye detection unit 44, using the detection result received from the eye detection unit 44, and outputs the shifted image to the image processing unit 42. Step S2 and subsequent steps are the same as those in the first embodiment.

In FIG. 11, the eye detection unit 44 and the image shift unit 45 are added to the image processing device 4 of the remote communication system 100 illustrated in FIG. 1, but the present invention is not limited thereto. The eye detection unit 44 and the image shift unit 45 may be added to the image processing device 4 of the exemplary configurations described as the first to third different exemplary configurations in the first embodiment, and other exemplary configurations described in the first embodiment. The eye detection unit 44 and the image shift unit 45 may be provided in the terminal device 2, and the image processing device 4 may receive an image that has undergone an image shift and generate a first image and a second image.

The image processing device 4a in the remote communication system 100a of the present embodiment is also implemented, for example, by the computer system illustrated in FIG. 10, like the image processing device 4 in the first embodiment. The eye detection unit 44 and the image shift unit 45 illustrated in FIG. 11 are implemented by a computer program stored in the storage unit 103 illustrated in FIG. 10 being executed by the control unit 101 illustrated in FIG. 10. The storage unit 103 illustrated in FIG. 10 is also used to implement the eye detection unit 44 and the image shift unit 45 illustrated in FIG. 11.

### Third Embodiment

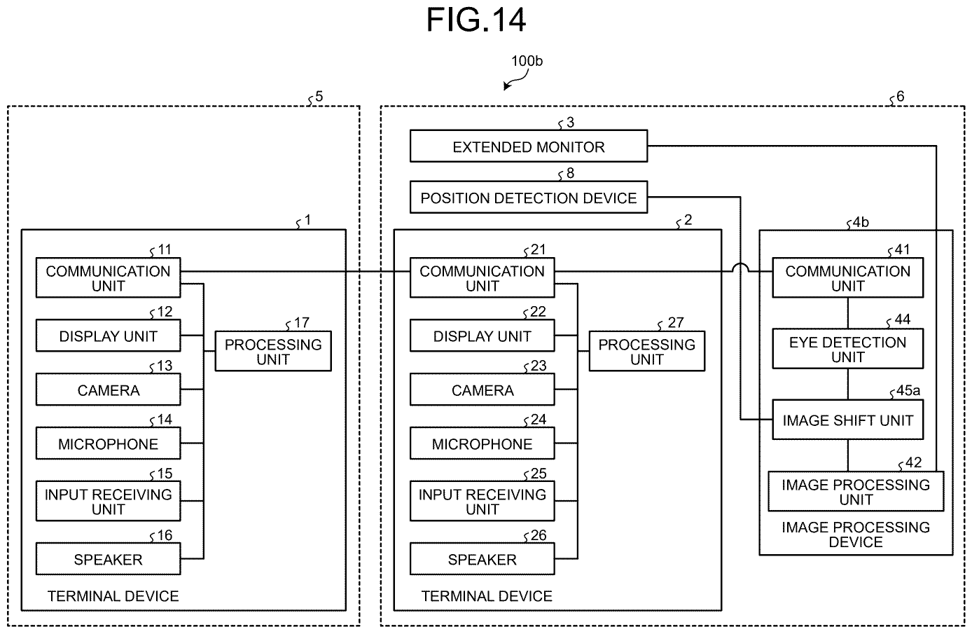

FIG. 14 is a diagram illustrating an exemplary configuration of a remote communication system according to a third embodiment. A remote communication system 100b of the present embodiment is the same as the remote communication system 100a of the second embodiment except that the remote communication system 100b includes an image processing device 4b instead of the image processing device 4a, and additionally includes a position detection device 8. Components having the same functions as those in the second embodiment are denoted by the same reference numerals as those in the second embodiment to omit redundant descriptions. Hereinafter, differences from the second embodiment will be mainly described.

The position detection device 8 detects the position of the terminal device 2. Specifically, the position detection device 8 detects the position of the terminal device 2 on the extended monitor 3, and notifies the image processing device 4b of position information indicating the detected position. In the case where the extended monitor 3 is a touch panel, the position detection device 8 may be integrated with the extended monitor 3 and implemented as a function of the extended monitor 3. In this case, for example, a touch panel sensitive sticker may be attached to the back of the terminal device 2. Alternatively, the position detection device 8 may be a camera that captures an image of the back of the terminal device 2, or may be a device that detects the position using light detection and ranging (LiDAR) and an inertial measurement unit (IMU) or the like provided in the back of the terminal device 2. In the case where the position detection device 8 is a camera that captures an image of the back of the terminal device 2, for example, an adjustment screen including a scale, numbers, marks, or the like for position detection is displayed on the extended monitor 3. The terminal device 2 or the image shift unit 45a of the image processing device 4b analyzes the image captured by the camera to calculate the position of the terminal device 2. Alternatively, a camera may be installed at the extended monitor 3 as the position detection device 8, and the terminal device 2 or the image shift unit 45a of the image processing device 4b may analyze an image captured by the camera to calculate the position of the terminal device 2. The position detection device 8 only needs to be able to detect the position of the terminal device 2 on the extended monitor 3, and is not limited to the above-described examples.

The image processing device 4b is the same as the image processing device 4a in the second embodiment except that the image processing device 4b includes an image shift unit 45a instead of the image shift unit 45. The image shift unit 45a shifts an image received from the eye detection unit 44, using a detection result received from the eye detection unit 44 and the position information received from the position detection device 8. That is, the image shift unit 45a determines a camera position that is the position of the camera 23, using the position of the terminal device 2 detected by the position detection device 8, and shifts the image such that the eye position detected by the eye detection unit 44 coincides with the camera position. For example, the image shift unit 45a calculates the position of the camera on the extended monitor 3, using the position information received from the position detection device 8 and information indicating the position of the camera 23 in the terminal device 2. The image shift unit 45a shifts the image by Xc-Xe and Yc-Ye where Xc and Yc are the coordinates of the calculated camera position, and Xe and Ye are the coordinates of the detection result received from the eye detection unit 44.

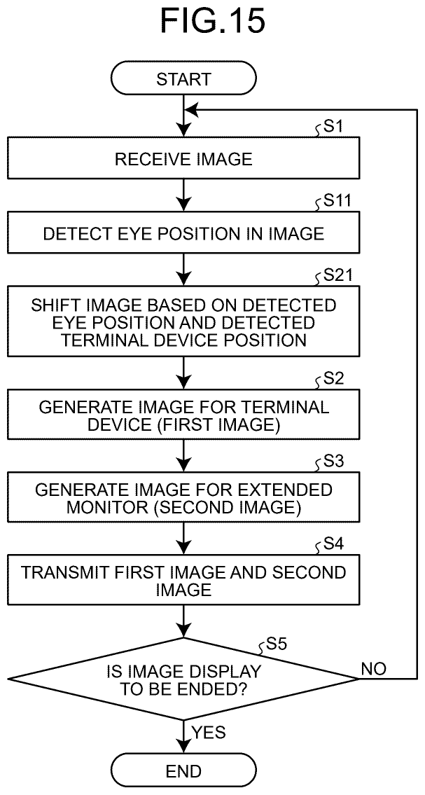

FIG. 15 is a flowchart illustrating an example of an image processing procedure of the present embodiment. Steps S1 and S11 are the same as those in the second embodiment. The image shift unit 45a shifts an image on the basis of a detected eye position and a detected position of the terminal device 2 (the position of the terminal device 2 detected by the position detection device 8) (step S21). Step S2 and subsequent steps are the same as those in the first embodiment.

By the above operation in the present embodiment, even when the disposition position of the terminal device 2 on the extended monitor 3 is not determined in advance, or even when the disposed position of the terminal device 2 on the extended monitor 3 is off a predetermined position, the position of the eyes of the first user in an image can be aligned with the position of the camera 23 in the terminal device 2 as in the second embodiment.

Although FIG. 14 illustrates an example in which the position detection device 8 is added to the remote communication system 100 illustrated in FIG. 1, and the image shift unit 45a is provided instead of the image shift unit 45, the present invention is not limited thereto. In the remote communication system 100 of the exemplary configurations described as the first to third different exemplary configurations in the first embodiment and other exemplary configurations described in the first embodiment, the position detection device 8 may be added, and the image shift unit 45a may be provided instead of the image shift unit 45. The eye detection unit 44 and the image shift unit 45a may be provided in the terminal device 2, and the image processing device 4 may receive an image that has undergone an image shift and generate a first image and a second image.

The image processing device 4b in the remote communication system 100b of the present embodiment is also implemented, for example, by the computer system illustrated in FIG. 10, like the image processing devices 4 and 4a of the first and second embodiments. The image shift unit 45a illustrated in FIG. 14 is implemented by a computer program stored in the storage unit 103 illustrated in FIG. 10 being executed by the control unit 101 illustrated in FIG. 10. The storage unit 103 illustrated in FIG. 10 is also used to implement the image shift unit 45a illustrated in FIG. 14.

### Fourth Embodiment

The remote communication systems 100, 100a, and 100b described in the first to third embodiments above can be applied to remote communication for various purposes. A fourth embodiment describes, as an example thereof, an example of use in combination with remote operation.

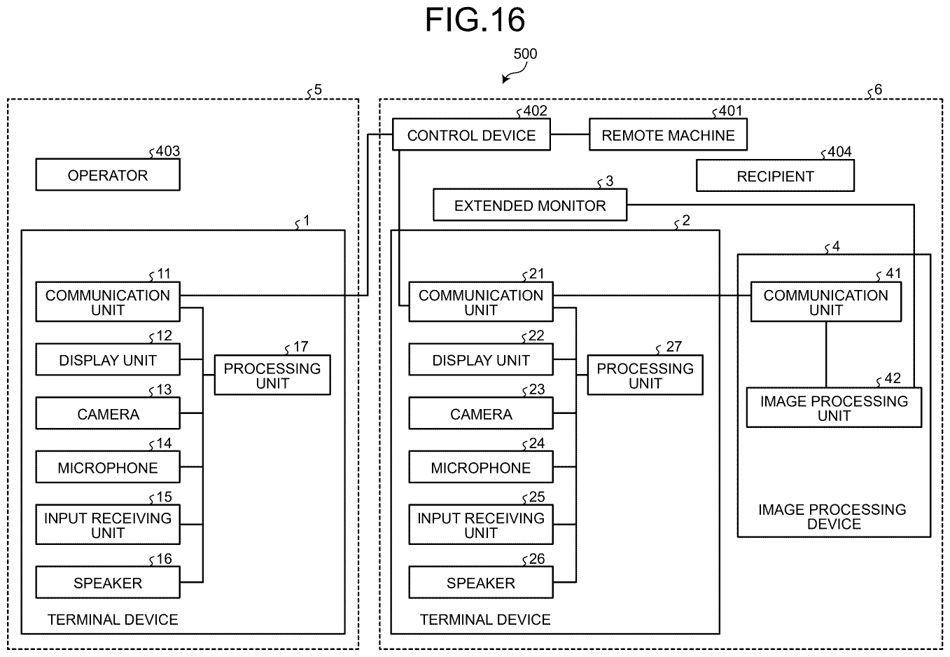

FIG. 16 is a diagram illustrating an exemplary configuration of a remote machine operation system 500 of the fourth embodiment. Components having the same functions as those in the first embodiment are denoted by the same reference numerals as those in the first embodiment to omit redundant descriptions. As illustrated in FIG. 16, the remote machine operation system 500 includes the terminal device 2, the extended monitor 3, and the image processing device 4 constituting the remote communication system 100 of the first embodiment. That is, the remote machine operation system 500 includes the remote communication system 100 of the first embodiment.

In the example illustrated in FIG. 16, an operator 403 who is the first user located at the first point 5 remotely operates a remote machine 401 located at the second point 6, using the input receiving unit 15 of the terminal device 1 as an operating means. Operating means such as a joystick, a touch pad, buttons, a keyboard, a mouse, and/or a game controller may be provided Separately from the terminal device 1, and the terminal device 1 may receive input from these operating means. The terminal device 1 transmits operating information indicating the content of an operation input from the operator 403 and images and sound described in the first embodiment to a control device 402. The control device 402 transmits a control signal for operating the remote machine 401 to the remote machine 401, using the operating information, and transmits the images and the sound to the terminal device 2. The remote machine 401 operates in accordance with the control signal. The remote machine 401 may be a machine with a manipulator, a moving vehicle or the like, or a moving machine with a manipulator, or may be other than these.

Note that the control device 402 may be integrated with the terminal device 2 or the image processing device 4. In FIG. 16, the control device 402 receives the operating information, images, etc. from the terminal device 1, but the present invention is not limited thereto. The terminal device 2 may receive the operating information, images, etc. from the terminal device 1 and transmit the operating information to the control device 402.

When a recipient 404 who is the second user is present near the remote machine 401, a sudden movement of the remote machine 401 can give a sense of unease to the recipient 404. When the operator 403 and the recipient 404 perform remote communication, the operator 403 can notify the recipient 404 of details of movement in advance, and the recipient 404 can notify the operator 403 of their situation, so that a sense of unease of the recipient 404 can be prevented. In the present embodiment, as described in the first embodiment, images are displayed on the terminal device 2 and the extended monitor 3 to allow the recipient 404 to make eye contact with the operator 403, so that smooth remote communication can be promoted. Although FIG. 16 illustrates an example in which the remote communication system 100 described in the first embodiment is used in the remote machine operation system 500, the present invention is not limited thereto. The remote communication system 100a or 100b described in the second or third embodiment may be used in the remote machine operation system 500.

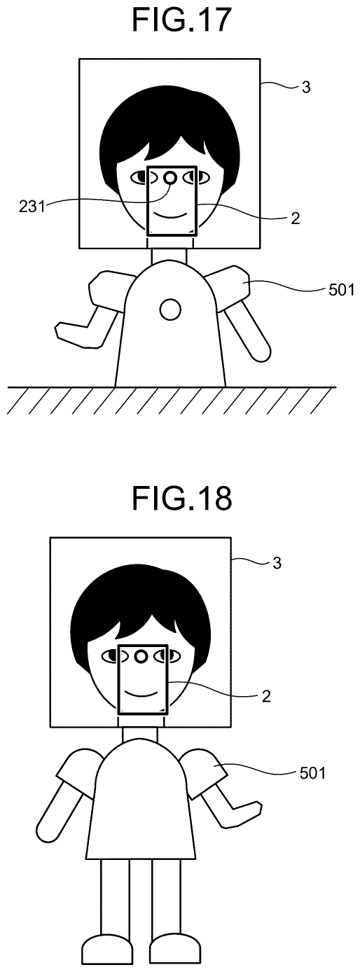

FIGS. 17 and 18 are diagrams illustrating how the terminal device 2 and the extended monitor 3 are used in the present embodiment. In examples illustrated in FIGS. 17 and 18, a communication avatar for communication is disposed near the remote machine 401, and the extended monitor 3 is used as part of the communication avatar. The communication avatar simulates, for example, at least part of the body of a human or an animal, such as a face, a waist, arms, and/or legs, which may be extremely deformed. In the examples illustrated in FIGS. 17 and 18, the extended monitor 3 is provided on the top of a base 501 corresponding to a trunk or the like. Thus, the extended monitor 3 is a portion corresponding to the face of the communication avatar. By using the terminal device 2 together with the extended monitor 3, the recipient 404 can make eye contact with the operator 403 via the communication avatar. In addition to the terminal device 2 and the extended monitor 3, the base 501 simulating a trunk and arms is provided as illustrated in FIG. 17, or the base 501 simulating a trunk, arms, and legs is provided as illustrated in FIG. 18, so that the recipient 404 can more smoothly communicate with the operator 403. Note that the shape of the base 501 is not limited to the examples illustrated in FIGS. 17 and 18.

Although the above has described the examples in which the terminal device 2 and the extended monitor 3 are used as part of the communication avatar, the base 501 may be the remote machine 401 itself. That is, for example, the extended monitor 3 may be provided on the top of the remote machine 401. The position of the extended monitor 3 at the remote machine 401 is not limited to the examples illustrated in FIGS. 17 and 18. In this case, by using the terminal device 2 together with the extended monitor 3, the recipient 404 can also make eye contact with the operator 403 and perform smooth communication, which can prevent uneasiness of the recipient 404 about the movement of the remote machine 401.

As described in the first to third embodiments, the application of remote communication is not limited to the application in the present embodiment.

The configurations described in the above embodiments illustrate an example, and can be combined with another known art. The embodiments can be combined with each other. The configurations can be partly omitted or changed without departing from the gist.

### REFERENCE SIGNS LIST

1, 1a, 1b, 2 terminal device; 3 extended monitor; 4, 4a, 4b image processing device; 5 first point; 6 second point; 8 position detection device; 11, 21, 41, 105 communication unit; 12, 22, 104 display unit; 13, 23 camera; 14, 24 microphone; 15, 25 input receiving unit; 16, 26 speaker; 17, 27, 43 processing unit; 42 image processing unit; 44 eye detection unit; 45, 45a image shift unit; 100, 100a, 100b remote communication system; 101 control unit; 102 input unit; 103 storage unit; 106 output unit; 107 system bus; 231 lens; 401 remote machine; 402 control device; 403 operator; 404 recipient; 500 remote machine operation system.

1.-8. (canceled)

9. A remote communication system to be used when a first user located at a first point and a second user located at a second point different from the first point communicate, the remote communication system comprising:
a first terminal device provided at the first point, to use an image of the first user from a first camera to capture an image of the first user, or a camera module virtually disposed in a virtual reality space to capture an image of the first user present in the virtual reality space as an avatar;
an image processing device to generate, using the image of the first user from the first terminal device, a first image that is part of the image of the first user, and a second image that is at least part of the image of the first user and is an image seamlessly continuous with the first image;
a second terminal device provided at the second point, to display the first image; and
an extended monitor provided at a back of the second terminal device, to display the second image.

10. The remote communication system according to claim 9, wherein
the second terminal device includes a second camera to capture an image of the second user, and
the second camera is provided at a position corresponding to a line of sight of the first user displayed on the second terminal device.

11. The remote communication system according to claim 9, wherein
the second terminal device includes a second camera to capture an image of the second user,
the remote communication system further comprises:
an eye detector to detect a position of eyes of the first user in the image of the first user; and
an image shifter to shift the image of the first user such that the position of the eyes detected by the eye detector coincides with a position corresponding to the second camera, and
the image processing device generates the first image and the second image, using the image of the first user that has been shifted by the image shifter.

12. The remote communication system according to claim 11, comprising:
a position detection device to detect a position of the second terminal device, wherein
the image shifter determines a camera position that is a position of the second camera, using the position of the second terminal device detected by the position detection device, and shifts the image such that the position of the eyes detected by the eye detector coincides with the camera position.

13. The remote communication system according to claim 9, wherein the second terminal device is a smartphone or a tablet.

14. The remote communication system according to claim 13, wherein the second terminal device is bezel-less.

15. A remote communication method for communication between a first user located at a first point and a second user located at a second point different from the first point, the remote communication method comprising:
capturing an image of the first user with a first camera provided at the first point, or capturing an image of the first user present in a virtual reality space as an avatar with a camera module virtually disposed in the virtual reality space;
generating, using the image of the first user captured with the first camera or the camera module, a first image that is part of the image of the first user, and a second image that is at least part of the image of the first user and is an image seamlessly continuous with the first image;
displaying the first image on a terminal device provided at the second point; and
displaying the second image on an extended monitor provided at a back of the terminal device.
